(19) United States
(12) Patent Application Publication
(10) Pub. No.: US 2005/0186967 A1
(43) Pub. Date: Aug. 25, 2005

(54) Multi-network location services support

(75) Inventor: Fatih Ozluturk, Port Washington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/014,253

(22) Filed: Dec. 16, 2004

Related U.S. Application Data
(60) Provisional application No. 60/546,292, filed on Feb. 20, 2004.

(51) Int. Cl. H04Q 7/20

(52) U.S. Cl. 455/456.1

(57) ABSTRACT

Location of a portable device with a transmitter, such as a wireless transmit/receive unit (WTRU) in a cellular telecommunications network, is obtained by a primary network augmented by data obtained from a diverse network. In a particular configuration, changes of the indication of the location of the portable device are used to update positional information, such as positional information obtained from a GPS receiver.

### CROSS REFERENCE TO RELATED APPLICATION(S)

This application claims the benefit of U.S. provisional application No. 60/546,292 filed on Feb. 20, 2004, which is incorporated by reference as if fully set forth.

### FIELD OF INVENTION

The present invention relates to wireless communication and to providing location data concerning mobile communication units, such as for emergency services number call locating.

### BACKGROUND

A wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a Node B, site controller, access point or any other type of interfacing device in a wireless environment. These exemplary types of wireless environments include, but are not limited to, wireless local area networks (WLANs) and public land mobile networks. In the context of the present invention, the portable nature of some WTRUs is significant. Portable WTRUs include cellular telephones, cellular telephones with data capability, wireless modems, as well as other devices.

Various communications services are provided on wireless networks such as cellular telephone networks. In addition, wireless networks with multiple RF services and multiple networks are becoming increasingly common. One type of multiple network service includes cellular base stations optimized for voice communications and “hot spot” access points, optimized for high volume data transfer. In some embodiments of such systems, the “hot spot” access points are integrated with the radio network providing audio communications.

Wireless communication networks are generally controlled with respect to their radio interface or controlled through a larger network. In the case of a cellular network, control of the radio interface is integrated with a cellular network control function. The cellular network control function is effected directly through a cellular network controller or by the cellular network controller through a local unit. The local unit may be a base station or a subsidiary controller such as a Node B. In contrast, access points (APs) are controlled with respect to their radio interface locally.

In the case of a universal mobile telecommunications system (UMTS), control of the radio interface is integrated with a radio network controller function. The radio network controller function is effected directly through a radio network controller (RNC) or by the RNC through a local unit such as a Node B. In these arrangements, the access points (APs) are controlled with respect to their radio interface locally although it is possible to communicate between the RNC and the APs, and to provide handoffs to or from APs.

It is possible to control multiple APs from a single controller module; however, such control results in an air interface which behaves as if communication is controlled at the AP. Since a wireless communication system includes multiple components, it is possible for some cellular network controller functions to be implemented through APs and it is possible for some functions generally accessed through APs to be accessed through a cellular communications network.

In the usual case, wireless communication networks provide communications directly through a network controlled by the carrier. APs provide communications either connected through the carrier or directly with a separate network. By way of example, an AP may provide a connection with a TCP/IP internet connection. Alternatively, an AP may establish a TCP/IP internet connection thorough a connection routed through the carrier. It is understood, however, that cellular communication can be carried on a wireless local area network (WLAN) through an AP and TCP/IP communication may be carried through a cellular network.

Obtaining location data for a WTRU beyond that provided by a determination of a localized radio reception area is useful for a number of reasons, such as providing emergency services and providing consumer directional assistance. Emergency services callers dial a police emergency number, whereupon emergency services are dispatched to the caller's location. This is accessed by using an emergency services number or universal emergency telephone number, such as “999” (UK), “911” (North America), “102” (Europe), etc.

Many emergency call centers have a feature called “marking of origin”. The phone number of the caller is transmitted via the network, and the address corresponding to the phone number is located in the database of the telephone network provider. By using digital maps and mapping applications, the position of the address can be shown on the map instantly as calls arrive.

In the case of landlines, the location of the caller is usually provided by telephone billing data or the like, referred to as automatic number identification (ANI) in North American SS 7 systems. Modifications of ANI, called “Enhanced 911” have been implemented in North America, but these services are still based on a fixed subscriber location.

In the case of mobile telephone services, the physical location is not inherent in the connection service. Cellular telephones are typically located by area code and prefix (if ANI is used), or by the fixed base station handling the particular call. Automatic Location Identification (ALI) is intended to provide physical location of cellular telephones, either by network based identification of location or by WTRU based geolocation.

There are instances in which ALI is unable to accurately determine the location of a WTRU, most notably when a GPS enabled WTRU is unable to acquire the GPS satellites. By way of example, metallization of a building will create a Faraday enclosure for GPS reception. Thus, while “Enhanced 911” mandates partial and full ALI capabilities, the ALI data may not be available. For the purposes of this invention, “GPS” is intended to describe GPS, as well as other wide area radio geolocation systems, such as GLONASS, Omega, Loran, etc.

In the US, “E 911” legislation was based largely on a government mandate that all cell phones were required to have location capability by the end of 2001. At the time of enactment, the political consensus developed that all a cell phone user had to do was turn on the phone and GPS capability would provide the user's precise location. The rate of compliance of newly manufactured phones was low, in part because of the high cost of GPS location technology and because of the difficulty of receiving sufficient GPS signals with mobile telephones, particularly from within an enclosure.

GPS location information is accurate when the GPS enabled device has acquired a sufficient number of satellites, but it is often the case that satellite coverage is lost. This is particularly the case with mobile GPS enabled equipment which is not intentionally positioned so as to receive the GPS signals. This substantially reduces the effectiveness of the GPS function. Another factor in the use of GPS location is that some WTRUs would normally be made without a GPS function. By way of example, WTRUs used to transfer data but not voice would normally be produced without a geolocation capability.

The availability of “hot spot” access points and other diverse communications networks often coincides with circumstances where ALI data is difficult to obtain. By way of example, “hot spot” access points are often available to users inside buildings. In another example, a user may be able to confirm generalized location near a base station but require communications through a diverse network.

A “hot spot” may be, for example, an access point meeting IEEE 802.11 standards or similar communications standards, and can be considered to be a WLAN or 802.11 access point. An 802.11 access point provides primary control of the air interface, and establishes a connection with an external communication network substantially independently of the air interface. In the typical case, the external communication network is an internet connection or is used to access an internet connection. While the internet connection can be established through the access point's wireless connection, for example through another access point, the external connection is ultimately established beyond the air interface of the access point. Thus, unlike a cellular telephone network, the 802.11 connection is typically not interconnected with a cellular network controller for the purpose of establishing radio connections. In this sense, a wireless connection of a WTRU to an access point is through a network external to the access point.

In some proposed configurations, ALI data is combined with a database of “hot spot” locations in order to provide WTRUs with information regarding the availability of services from “hot spot” access points. Once a candidate “hot spot” is identified, the WTRU is able to establish that it can or cannot establish a connection with the “hot spot” access point.

Location based services exist for the benefit of wireless users. One such service provides driving directions, which can be used in association with cellular telephones. Generally it is necessary for the user of such services to provide “from” information in the form of current location prior to obtaining directions “to” a desired destination. In addition to requiring an extra step of user interaction, the user is often lost, at least to the extent of not being able to identify the user's particular location. The provision of local position information beyond that provided by cells and cell sectors would allow such direction information services to determine the “from” information without requiring user input.

Various location services have been proposed and implemented in order to provide accurate information for identifying the location of a mobile telephone. These include identification of the fixed base station, cellular GPS, and network TDOA in which a comparison is made of the travel time from the cell phone to several location measurement units installed at base stations. The location measurement units are radio receivers that perform high speed cross correlation of detected signals and are typically rack mounted at the base station.

Location based services currently are being standardized in many air interfaces and is starting to become part of the wireless experience. Current systems typically use time delay information from multiple base stations and triangulate to estimate the location of the user. If there are multiple systems overlapping, such as the case with WLAN and UMTS often times, each system is expected to do its own location estimation. Accordingly, it is desirable to have improved geolocation services.

### SUMMARY

In accordance with the present invention, data from multiple wireless network connections are combined in order to provide increased accuracy in determining location of WTRUs. In a specific configuration, a cellular wireless network and a local wireless network of a diverse type cooperate in generating location data for a WTRU.

In accordance with a particular embodiment of the present invention location information in a wireless network for the purpose of identifying the locations of user WTRUs is augmented by use of information obtained from a diverse network.

In a further embodiment of the invention, data, such as GPS data, used to obtain location of the user's WTRU independently of the diverse network is combined with the data obtained by using the locations of the diverse network. The diverse network may be used to determine changes in location of the portable device by making correction adjustments to the secondary location data. This provides continuity of location information of the user's WTRU by combining the primary location data with the secondary location data.

### BRIEF DESCRIPTION OF THE DRAWINGS

FIG. 1 is a diagram showing the implementation of an exemplary embodiment of the invention.

FIG. 2 is a diagram showing a modification of the present invention, in which GPS or other position data is used.

FIG. 3 is a flow diagram showing estimation of position in accordance with the present invention.

### DETAILED DESCRIPTION OF THE PREFERRED EMBODIMENTS

The invention provides an extension of location detection and location based services to a multi network environment where the user location is determined with greater accuracy due to new information being available, and location information is shared across multiple networks to aid location based services in one network using the location information obtained in another network.

Location detection and location services are traditionally, defined only in the context of a single network and single mechanism to determine the user's location. This invention allows user location estimates from multiple networks to be used together to get a better estimate of the user location, as well as sharing of the location information from one network to enable location based services in another network.

The present invention makes location estimation much more accurate by making use of location estimates from multiple networks to increase accuracy of the estimate. Since there is more information available in the case of multiple networks more accurate estimation can be obtained. For instance, location estimation in WLAN coverage can be accurate down to a few feet (a meter), whereas the accuracy in UMTS is only accurate over several meters. If the two networks shared this information, it would be possible to know where a user is in UMTS system is down to a few feet.

Another benefit of the invention is that location information from one network can be transferred to another and enable location based services.

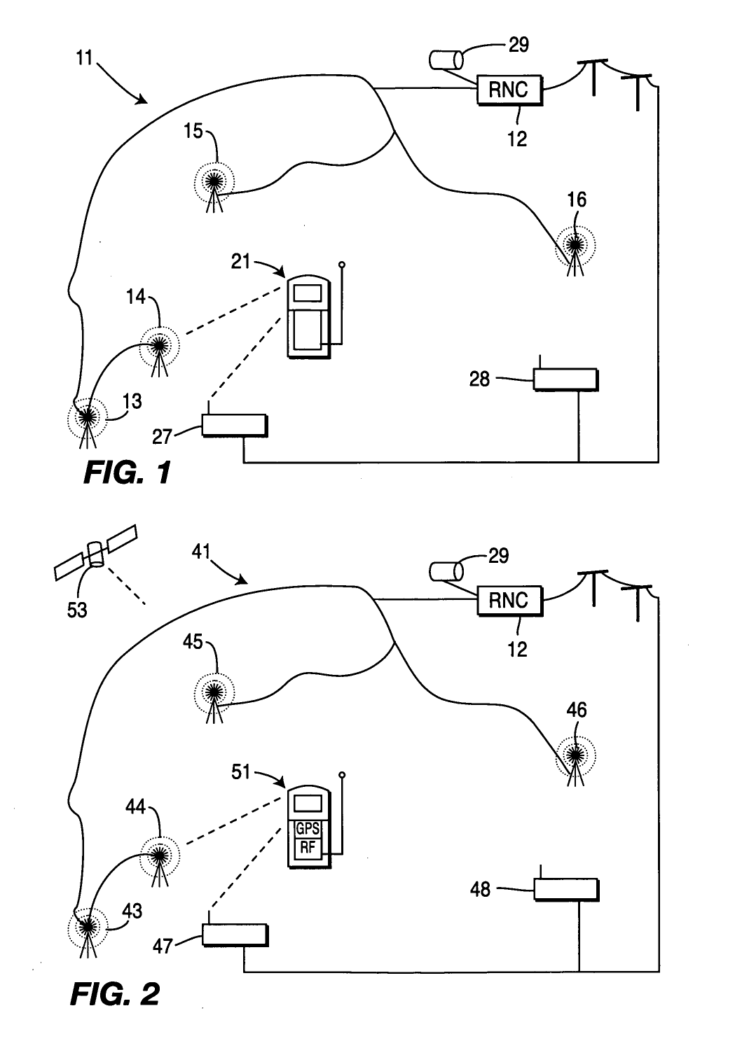

FIG. 1 is a diagram showing the implementation of an exemplary embodiment of the invention. A wireless radio network 11 includes a cellular network controller 12, and a plurality of base stations 13, 16. A WTRU 21 is able to communicate with one or more of the base stations, such as base station 14 depicted in FIG. 1. Typically communication is maintained by the WTRU 21 with a single one of the base stations except during handoff or other special circumstances.

Local “hot spot” access points 27, 28 are also able to establish wireless contact with the user WTRU 21. “Hot spot” access points 27, 28 are wireless network services which typically have a range which is more limited than that afforded by cellular base stations, but which are optimized for providing high data rates. In some cases, “hot spot” access points 27, 28 are integrated into the cellular network or are able to communicate with the cellular network.

Signals from the user's WTRU 21 are received by the cognizant base stations 13 16, and values are received to indicate position information. In addition to signals received from the base station 14 assigned to the user's WTRU 21, it is likely that one or more of the base stations 13, 16 receive sufficient signal information to identify the user's WTRU 21. This information is combined with information from the hot spots 27, 28 in two ways. First, the hot spots 27, 28 are able to provide an indication of proximity of the WTRU 21 by signal strength. This method is most effective for “hot spots” which are very localized, such as may be provided at a business for the business' customers. This information is used by the cellular network controller 12 as an indication of possible positions for the WTRU 21. The WTRU 21 is presumed to be in a position which would coincide with a signal strength measured by the “hot spot” access point 27.

Secondly, the “hot spot” access points 27 28 are able to provide some location services, and thereby provide positional data. This method is most effective in the case of hot spots intended for users in a large area, such as several city blocks. A method of deriving location information by the hot spot access point is to calculate the relative delay between the transmitted and received signals and thereby infer the distance that the signal travels. This gives an indication of the distance of the WTRU from the access point.

The latter method is useful for combining the location services of several networks. Thus, while competitive networks may or may not provide connections to WTRUs within their coverage areas, such networks may be able to provide location data to a network used by the WTRU for communications services.

In the depicted case, the WTRU 21 communicates through base station 14 to an extent necessary to identify the WTRU 21 as being within the coverage area or cell of the base station 14. In addition, “hot spot” access point 27 also communicates with the WTRU 21 to an extent necessary to identify the WTRU 21 as being within the coverage area of the “hot spot” access point 27. This information is certainly sufficient for the cellular network controller and the network associated with the “hot spot” access point 27 to determine that the WTRU 21 is within the respective coverage areas. In some instances, the base station 14 is also able to obtain location information concerning the WTRU 21.

The location information may be geolocation data provided by the WTRU 21. A geolocation determination by the WTRU 21 is typically by use of a GPS receiver in the WTRU 21, as will be described infra. The base station 14 may use positioning calculations such as TDOA calculations or other location techniques to determine the position of the WTRU 21. If the base station 14 obtains geolocation data provided by the WTRU 21, this data is generally considered accurate and further calculations would be unnecessary. In practice, however, geolocation data from the WTRU is often either unavailable or intermittent. GPS data in particular is unavailable without a clear RF view of several satellites. Often building materials and other environmental factors will block the satellite signals, and a clear RF view does not exist. For this reason, the base station 14 may augment GPS data with other location data.

According to the present invention, the cellular network controller associated with a primary network obtains location data directly, and indirectly from a diverse network. This data from the diverse network is combined with data obtained from the primary network. The cellular network controller then combines the data in order to obtain a position estimate optimized by inclusion of data from both the primary network and the diverse network.

Information concerning the location data from the diverse network may come directly from the diverse network, or may be stored by the cellular network controller in a database 29. In many cases, the database 29 will include general information concerning the locations of one or more “hot spots” which are reception areas of the diverse network. This data can be obtained by using a directory of “hot spot” locations, by querying the “hot spot” access point, or by historical data regarding coincidences between known locations of WTRUs connected to the access points.

In the example shown in FIG. 1, the primary network would include base stations 13, 16, so that the data would be obtained by information obtained from base station 14. The diverse network would include “hot spots” 27, 28, and the cellular network controller would combine the information obtained from base station 14 with information from “hot spot” access point 27.

The radio network is then able to use the information from all of these sources to find the location of the emergency services number caller directly, or alternatively to provide supplemental location information for other methods, (such as TDOA).

In many circumstances, a diverse network serving “hot spots” will not have data available concerning the geographical locations of “hot spot” access points, or will only have generalized address data. To the extent that the “hot spot” access point can be identified by the cellular network controller 12 with a known location of a WTRU, the cellular network controller 12 may include that “hot spot” location to augment the database.

FIG. 2 is a diagram showing a wireless network 41 according to a modification of the present invention. As depicted in FIG. 2, GPS or other position data is enhanced by location data obtained by a combination of base stations 43, 46 and a diverse network 47, 48. The user's WTRU 51 has a GPS or other position location circuit 52. If the user's WTRU 51 is able to acquire enough satellites, the user's WTRU 51 can accurately report its position to the cellular network controller 12. GPS data, represented by satellite 53 is considered to be more accurate than data obtained from comparing signals received by the diverse network 47, 48 or comparing signals received by the base stations 13, 16 from the user's WTRU 51 with signals received from the diverse network 47, 48.

It is anticipated that the GPS data, while more accurate, will frequently be unavailable. According to one aspect of the invention, when the GPS data is unavailable, the information obtained by comparing signals from the user's WTRU 51 with the signals received by the diverse network 47, 48 will be used to update the GPS data. In a particular embodiment, the information obtained by comparing signals from the user's WTRU 51 with the signals received by the diverse network 47, 48 is used to indicate positional changes in the WTRU 51, thereby modifying the GPS data primarily by adjusting the GPS data in accordance with a sensed change, rather than generating new positional information independently of the GPS data.

Information concerning the location data from the diverse network is enhanced by the use of GPS data from WTRUs because in many cases data concerning the locations of “hot spots” is not readily available to the primary network. In instances where GPS reception is available during connection to a “hot spot” access point, data concerning the coincidence of the GPS data and the “hot spot” connection can be stored in the database 29. In this way, later connections to the “hot spot” access point can be presumed to coincide with the previously reported GPS data. This is significant because in many cases, most individual connections to a given “hot spot” will not include the availability of GPS data.

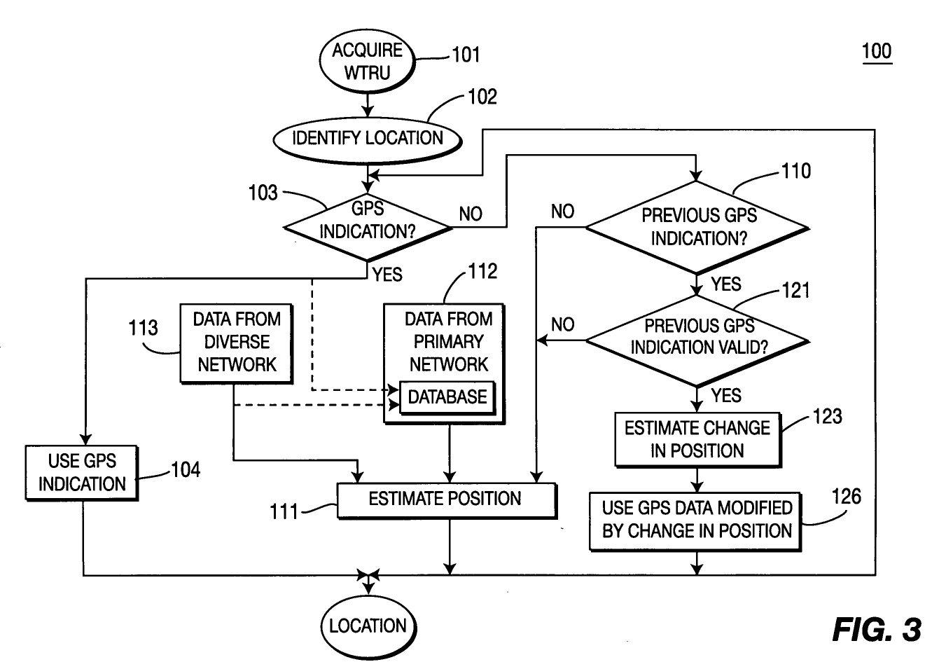

FIG. 3 is a flow diagram 100 showing estimation of position in accordance with the present invention. A WTRU is acquired by a primary network or a diverse network (step 101) and in response, the acquiring network attempts to identify the location of the WTRU (step 102). The identification of the location (step 102) can be initiated when the WTRU is acquired or delayed until a further communication link is established.

A determination is made as to whether the WTRU can provide positional information, typically based on GPS geolocation (step 103). If the GPS positional information is available, it is used (step 104). The determination and use of GPS data (steps 103 and 104) is given by way of example, and any determination that location data of a predetermined accuracy can be employed.

If the GPS positional information is not available, as determined by step 103, a determination is made as to whether a previous GPS indication is available (step 110) and whether the previous GPS indication is valid (step 121). Validity would depend on, time and movement, and concordance of the GPS data with local position indications for the WTRU.

If a valid previous GPS indication is unavailable, an estimate of position is made (step 111), using data provided by the primary network (step 112) and data obtained from a diverse network (step 113). This can be performed by the primary network independently of the diverse network as well as by use of the diverse network. In the case of data obtained from the diverse network (step 113) database data provided by the primary network is used to provide additional information. Given the circumstance in which the primary network attempts to obtain location data, the WTRU is assigned to a particular base station, and the primary network obtains data available from that base station. Often the network is able to use data from neighboring base stations in addition to the base station to which the WTRU is assigned. The data from the base stations of the primary network is resolved to the extent of the capabilities of the primary network for use in determining the location of the WTRU. In addition, data is obtained from the diverse network. This data can be position determinations which are deemed to have a particular accuracy. The data from the diverse network is combined with the data from the primary network in order to obtain more precise location estimates of the WTRU. This diverse network data can be obtained from multiple diverse networks.

The data from the diverse network can vary from general information that the diverse network is able to identify the WTRU within its coverage area to data concerning specific location within a particular access point of the diverse network. The accuracy of the data and the ability of the data to limit the possible position estimates made by the primary network must then be determined. In one embodiment, the data from the diverse network is itself self limiting. The primary network can then combine the data with data directly obtained by the primary network, by use of a database. For example, if the diverse network has a specific geographic coverage area within which WTRUs can be identified, the data from the diverse network is that the WTRU is within that geographic area. On the other hand, the diverse network may provide specific position estimates. The position estimates may include precision data or precision data may be separately obtained. The data from the diverse network can be compared with data associating that data with further data. Further data can include geographical location data, a database associating signal values with possible locations, a predetermination of the accuracy of location data obtained by the diverse network, and an association between position fixes or values provided by the diverse network with location determinations of known accuracy.

In the case of ambiguity, it is a matter of design choice as to which data is accepted as true. It is possible to obtain some verifications of position, for example by obtaining GPS location readings and comparing the GPS reading to the estimate. These verifications can be used to provide corrections to future position estimates.

If a previous GPS indication is determined valid (step 121), an estimation of a change in position is made (step 123). This can be performed by the primary network independently of the diverse network, by use of the diverse network, or by the primary network using data from the primary network in combination with data from the diverse network. The estimation of change in position is then used to modify the reported GPS position, so that the reported position is based on the GPS position (step 126), and not solely by an independently generated position estimate.

The validity of a previous GPS estimate may be modified by the availability of rate sensing data from the WTRU, as represented by the dashed lines in the diagram. To the extent that the rate information is deemed to be more reliable than change in signals received by the diverse network, the rate information is considered when determining the validity of the GPS data.

If the WTRU provides the user with GPS based navigational data, the network can update the GPS data according to the determinations made by the network regarding location. This provides the user with a continuation of GPS based navigational data in instances where the GPS data may be intermittent.

It is possible to combine GPS data with data from the primary and diverse networks in a manner which permits the diverse network to augment or substitute for the GPS data when the GPS data is unavailable. The GPS data is received from the user's WTRU during times of availability of the GPS data, thereby providing primary location data concerning location of the user's WTRU. Location data from the diverse network is used during times of unavailability of the GPS data, thereby providing secondary location data concerning location of the user's WTRU. This permits the GPS data to be used as primary location data, while using the diverse network, the primary network or a combination of the diverse network and primary network to make correction adjustments. This allows the use of the GPS, while providing continuity of location information of the user's WTRU by combining the location data from the GPS with secondary location data.

The above descriptions include the use of a primary network and a diverse network. The diverse network can include “hot spot” access points administered by the primary network or “hot spot” access points or other access points administered independently of the primary network. The diverse network can also be different network services such as an analog network or a network which permits “roaming” off network by users. The location service can be performed by the diverse network as well as by the primary network, and in particular this will occur if a user engages emergency services while in a “roaming” mode. In the case of the location service being performed by the diverse network, the functions described above in association with the primary network can be performed by the diverse network, with the functions described above in association with the diverse network performed by the primary network or by another diverse network.

In concept, the above descriptions include the use of a wireless network controlled by a cellular network controller and a locally controlled network which includes one or more access points (APs). The APs may be administered by the cellular network controller or administered independently of the cellular network controller, but behave as independent groups of one or more radio interfaces. Data from the networks are combined in order to provide increased accuracy in determining location of WTRUs. Further location data, such GPS data, may be used to obtain location of the user's WTRU independently of the networks and is combined with data obtained by using the locations of transceivers associated with the locally controlled network and location information obtained from the wireless network controlled by the cellular network controller. This provides continuity of location information of the user's WTRU by combining the primary location data, for example from the GPS, with the secondary location data.

Although the features and elements of the present invention are described in the preferred embodiments in particular combinations, each feature or element can be used alone (without the other features and elements of the preferred embodiments) or in various combinations with or without other features and elements of the present invention.

1. A method for estimating location of a wireless transmit/receive unit (WTRU) in a wireless network, in which the wireless network includes a cellular network controller and at least one base station for communication with users through a plurality of WTRUs, and in which a diverse network provides further communication services, the method comprising:
establishing communication with a user WTRU; and
using the location data obtained from the diverse network to provide data concerning location of the user WTRU.

2. The method of claim 1, comprising combining the location data obtained from the diverse network with a database, the database associating the location data obtained from the diverse network with further data.

3. The method of claim 1, comprising combining the location data obtained from the diverse network with a database, the database associating the location data obtained from the diverse network with further data, where the further data includes one of geographical location data, a database associating signal values with possible locations, a predetermination of the accuracy of location data obtained by the diverse network, or an association between position fixes or values provided by the diverse network with location determinations of known accuracy.

4. The method of claim 1, comprising determining the locations by comparing signals from the user WTRU with signals from the diverse network.

5. The method of claim 1, comprising:
receiving GPS data from the user's WTRU during times of availability of the GPS data, thereby providing primary location data concerning location of the user's WTRU;
using the locations of the diverse network during times of unavailability of the GPS data, thereby providing secondary location data concerning location of the user's WTRU; and
using the primary location data to make correction adjustments to the secondary location data, thereby providing continuity of location information of the user's WTRU by combining the GPS data with the secondary location data.

6. The method of claim 1, comprising combining the location data obtained from the locally controlled network with a database to associate the location data obtained from the locally controlled network with the data which includes one of geographical location data, a database associating signal values with possible locations, a predetermination of the accuracy of location data obtained by the locally controlled network, or an association between position fixes or values provided by the locally controlled network with location determinations of known accuracy.

7. The method of claim 6 wherein the wireless network including the cellular network controller includes a cellular network for communication with users through a plurality of wireless transmit/receive units (WTRUs), at least one base station, and in which the cellular network controller effects control of a radio interface between the base station and the WTRU, and the diverse network controls a radio interface primarily by the WTRU and a local station of the diverse network substantially independently of network control.

8. The method of claim 6, comprising providing the locally controlled network as an access point.

9. The method of claim 6, comprising:
providing the locally controlled network as an access point;
receiving GPS data from the user's WTRU during times of availability of the GPS data, thereby providing primary location data concerning location of the user's WTRU;
using the locations of the locally controlled network during times of unavailability of the GPS data, thereby providing secondary location data concerning location of the user's WTRU; and
using the primary location data to make correction adjustments to the secondary location data, thereby providing continuity of location information of the user's WTRU by combining the GPS data with the secondary location data.

10. The method of claim 6, comprising:
receiving GPS data from the user's WTRU during times of availability of the GPS data, thereby providing primary location data concerning location of the user's WTRU;
using the locations of the locally controlled network during times of unavailability of the GPS data, thereby providing secondary location data concerning location of the user's WTRU; and
using the primary location data to make correction adjustments to the secondary location data, thereby providing continuity of location information of the user's WTRU by combining the GPS data with the secondary location data.

11. The method of claim 6, comprising:
the cellular network effecting control of a radio interface between the base station and the WTRU, with the diverse network controlling a radio interface substantially independently of the network control;
establishing communication with a user WTRU; and
using the location data obtained from the diverse network to provide data concerning location of the user WTRU.

12. The method of claim 11, comprising combining the location data obtained from the diverse network with a database, the database associating the location data obtained from the diverse network with further data, where the further data includes one of geographical location data, a database associating signal values with possible locations, a predetermination of the accuracy of location data obtained by the diverse network, or an association between position fixes or values provided by the diverse network with location determinations of known accuracy.

13. A method for providing updated position information for locating a portable device having a transmitter and a GPS receiver in instances of intermittency of GPS geolocation, the method comprising:
providing a primary communications network and establishing a communications link between the portable device and the communications network;
obtaining further location data of the portable device by use of a diverse communications network;
using the further location data to determine changes in location of the portable device during interruptions in GPS geolocation.

14. The method of claim 13 wherein the primary communication network includes a cellular network for communication with users through a plurality of wireless transmit/receive units (WTRUs), at least one base station, and in which the primary network includes a cellular network controller, the cellular network controller effects control of a radio interface between the base station and the WTRU, and the diverse network controls a radio interface primarily by the WTRU and a local station of the diverse network substantially independently of the network control.

15. The method of claim 13 further comprising using a database, and combining data in the database with the obtained further location data.

16. The method of claim 13, comprising combining the location data obtained from the diverse communications network with a database, the database associating the location data obtained from the diverse communications network with further data, where the further data includes one of geographical location data, a database associating signal values with possible locations, a predetermination of the accuracy of location data obtained by the diverse communications network, or an association between position fixes or values provided by the diverse communications network with location determinations of known accuracy.

17. The method of claim 13, comprising determining the locations by comparing signals from the user WTRU with signals from the diverse communications network.

18. A system for providing location information in a wireless network, in which the wireless network includes a cellular network controller, and at least one base station, for communication with users through a plurality of wireless transmit/receive units (WTRUs), the method comprising:
a communications link between the wireless network and at least one diverse network;
a circuit for obtaining location data from at least one of the network and a user WTRU;
a circuit for receiving further location data from the diverse network; and
a circuit for combining the further location data with location data from at least one of the network or the user WTRU, and using the combined location data to provide a location estimate.

19. The system of claim 18 wherein the wireless network includes a cellular network for communication with users through a plurality of wireless transmit/receive units (WTRUs), at least one base station, and in which the primary network includes a cellular network controller, the cellular network effects control of a radio interface between the base station and the WTRU, and the diverse network controls a radio interface primarily by the WTRU and a local station of the diverse network substantially independently of the network control.

20. The system of claim 18, comprising a database for storing information concerning the data from the diverse network.

21. The system of claim 18, comprising a circuit for determining the locations by comparing signals from the user WTRU with signals from the diverse network.

22. The system of claim 18, comprising:
a circuit for receiving GPS data from the user's WTRU during times of availability of the GPS data, thereby providing primary location data concerning location of the user's WTRU;
a circuit for using the locations of the diverse network during times of unavailability of the GPS data, thereby providing secondary location data concerning location of the user's WTRU; and
a circuit for using data obtained by the network from at least one of the network and the diverse network to make correction adjustments to the GPS data, thereby providing continuity of location information of the user's WTRU by combining the GPS data with the data obtained by the network.

23. A wireless transmit/receive unit (WTRU) capable of providing location data to a first wireless network, and capable of establishing a wireless communication link with a diverse network, the WTRU comprising:
circuitry configured to provide data to the first network identifying existence of the wireless communications link with the diverse network, thereby providing an indication to the first network of a location of the WTRU in a reception area of the diverse network.

24. The WTRU of claim 23 wherein the first wireless network provides communication with the WTRU in a cellular network environment, whereby the WTRU communicates with the wireless network through at least one base station in a shared air interface, and the diverse network controls a radio interface primarily by the WTRU and a local station of the diverse network substantially independently of the network control.

25. The WTRU of claim 23, further comprising:
a circuit for establishing a wireless the first network and the WTRU;
a circuit for receiving GPS data, thereby providing primary location data concerning location of the user's WTRU during availability of the GPS data.

26. The WTRU of claim 23, further comprising:
a circuit for receiving GPS data and establishing a geopositional fix from the received GPS data;
a circuit for providing the first network with the geopositional fix;
a circuit configured for indicating to the first network a coincidence of the geopositional fix and a predetermined signal status between the WTRU and the diverse network, thereby providing the first network with an indication of geolocation coincident with the predetermined signal status.

27. A system for providing location information in a wireless network, in which the wireless network includes a cellular network controller, and at least one base station, for communication with users through a plurality of wireless transmit/receive units (WTRUs), the method comprising:
a communications link between the wireless network and at least one locally controlled network;
a circuit for obtaining location data from at least one of the network and a user WTRU;
a circuit for receiving further location data from the locally controlled network; and
a circuit for combining the further location data with location data from at least one of the network or the user WTRU, and using the combined location data to provide a location estimate.

28. The system of claim 27 wherein the diverse network controls a radio interface primarily by the WTRU and a local station of the diverse network substantially independently of the network control.

29. The system of claim 27, wherein the locally controlled network provides an access point (AP) interface.

30. The system of claim 29, comprising a circuit for determining the locations by comparing signals from the user WTRU with signals from the locally controlled network.

31. The system of claim 29, comprising:
a circuit for receiving GPS data from the user's WTRU during times of availability of the GPS data, thereby providing primary location data concerning location of the user's WTRU;
a circuit for using the locations of the locally controlled network during times of unavailability of the GPS data, thereby providing secondary location data concerning location of the user's WTRU; and
a circuit for using data obtained by the network from at least one of the network and the locally controlled network to make correction adjustments to the GPS data, thereby providing continuity of location information of the user's WTRU by combining the GPS data with the data obtained by the network.

32. A method for estimating location of a wireless transmit/receive unit (WTRU) in communication with a first network, the method comprising:
establishing a communication link with a diverse wireless network; and
using the location data obtained from the diverse network to provide data to the first network concerning location of the user WTRU.

33. The method of claim 32, comprising combining the location data obtained from the diverse network with a database, the database associating the location data obtained from the diverse network with further data, where the further data includes one of geographical location data, a database associating signal values with possible locations, a predetermination of the accuracy of location data obtained by the diverse network, or an association between position fixes or values provided by the diverse network with location determinations of known accuracy.

34. The method of claim 32, comprising:
receiving GPS data from the user's WTRU during times of availability of the GPS data, thereby providing primary location data concerning location of the user's WTRU; and
using the locations of the diverse network during times of unavailability of the GPS data, thereby providing secondary location data concerning location of the user's WTRU.
